(19) United States
(12) Patent Application Publication
(10) Pub. No.: US 2014/0225861 A1
(43) Pub. Date: Aug. 14, 2014

(54) TOUCH INTERFACE DETECTION CONTROL SYSTEM AND TOUCH INTERFACE DETECTION CONTROL METHOD

(71) Applicant: Konami Digital Entertainment Co., Ltd., Tokyo (JP)

(72) Inventors: Hirokatsu Yamaguchi, Minato-ku (JP); Shogo Azuma, Minato-ku (JP); Junichi Yamaguchi, Minato-ku (JP)

(73) Assignee: Konami Digital Entertainment Co., Ltd., Tokyo (JP)

(21) Appl. No.: 14/041,175

(22) Filed: Sep. 30, 2013

(30) Foreign Application Priority Data
Feb. 14, 2013 (JP) 2013-026748

(51) Int. Cl. G06F 3/045; G07F 17/32

(52) U.S. Cl. CPC G06F 3/045; G07F 17/3244
USPC 345/174; 463/25

(57) ABSTRACT

A detection control system is provided that is capable of preventing erroneous operation of a touch interface of the single touch type. In a detection control system for a touch panel that controls detection of the position of operation of a touch panel that employs the single touch method: a series of operation positions upon the touch interface are detected from a first operation position at which the user starts initial operation to a second operation position at which he terminates final operation; a valid operation region is set by taking the first operation position as a reference; it is determined whether or not the second operation position has been detected within the valid operation region; and detection of the second operation position is invalidated on the basis of the result of this determination.

### CROSS-REFERENCE TO RELATED APPLICATION

This application claims priority to Japanese Patent Application No. 2013-026748, filed Feb. 14, 2013, the disclosure of which is hereby incorporated by reference in its entirety.

### TECHNICAL FIELD

The present invention relates to a detection control system or the like that detects a position upon a touch interface where operation is performed.

### BACKGROUND ART

A game machine that utilizes a touch interface such as a touch panel that is laid over a display device or the like as an input device is per se known (for example, refer to Patent Document #1).

Patent Document #1: Japanese Laid-Open Patent Publication 2011-229769.

### SUMMARY OF INVENTION

### Technical Problem

Two types of touch interface exist: a single touch type that detects touch operation at only a single point, and a multi touch type that detects simultaneous touch operation at two or more points. With the single touch type, even when operation is performed at several points at the same time, only touching at a single point is detected. Since touch interfaces of the single touch type are much cheaper than those of the multi touch type, they are often used in game machines. On the other hand, if a game is provided that is supposed to be played with touch operation by both hands, or by a plurality of players, then there is a danger of erroneous operation, because, with a single touch type touch interface, it is only possible to detect touch operation at one point at once.

Therefore, the present invention aims to provide a detection control system etc., capable of preventing erroneous operation of a touch interface of the single touch type.

### Solution to Technical Problem

The touch interface detection control system of the present invention is a detection control system for a touch interface that controls detection of a position of operation of a touch interface that employs the single touch method, comprising: a position detection device that detects a series of operation positions upon the touch interface from a first operation position at which a user starts initial operation to a second operation position at which the user terminates final operation; a valid operation region setting device that sets a predetermined valid operation region by taking the first operation position as a reference; a position determination device that determines whether or not the second operation position has been detected within the valid operation region; and an operation invalidation device that invalidates detection of the second operation position on the basis of a result of determination by the position determination device.

The touch interface detection control method for a touch interface of the present invention is a detection control method for a touch interface that controls detection of a position of operation of a touch interface that employs the single touch method, comprising: a position detection step of detecting a series of operation positions upon the touch interface from a first operation position at which a user starts initial operation to a second operation position at which the user terminates final operation; a valid operation region setting step of setting a predetermined valid operation region by taking the first operation position as a reference; a position determination step of determining whether or not the second operation position has been detected within the valid operation region; and an operation invalidation step of invalidating detection of the second operation position on the basis of a result of determination by the position determination step.

According to the present invention, the operation valid range is set by taking the first operation position at which the user starts initial operation as a reference, and it is determined whether or not operation that constitutes erroneous operation has occurred by determining whether or not the second operation position, when operation terminates, is within the operation valid range. If erroneous operation has been determined, then the detection of the second operation position is invalidated. Since the operation is invalidated, accordingly no action is executed on the basis of the operation processing, so that it is possible to prevent erroneous operation.

With one aspect of the detection control system of the present invention, the operation invalidation device invalidates the detection of the second operation position, when the second operation position has not been detected within the valid operation region. According to this, erroneous operation is determined upon if the second operation position has been detected at a position which is removed from any position at which the user can possibly have actually performed operation. By invalidating the detection of the second operation position, it is possible to prevent operation from taking place that the user does not intend.

And, with another aspect of the detection control system of the present invention, the operation invalidation device invalidates the detection of the second operation position, when the second operation position has not been detected within the valid operation region, and moreover the second operation position is positioned within a predetermined invalid operation region. According to this, the detection of the second operation position is invalidated if the second operation position is not included in the valid operation region and is included in the invalid operation region. By setting such an invalid operation region, it is possible to invalidate operation only for operations that are not desired because they would lead to erroneous operation, and thus it is possible to optimize the control range.

Moreover, with another aspect of the detection control system of the present invention, the invalid operation region includes an operation reception region in which further operation by the user is received. Moreover, with this aspect, the touch interface is provided to a game machine that charges a fee to the user for playing, and then permits the user to play a game; and the operation reception region is a region that receives operation corresponding to the payment of the playing fee. By doing this, it is possible to prevent erroneous operation in connection with operations that would exert an influence upon fee charging.

### Advantageous Effects of Invention

As has been explained above, according to the present invention, the operation valid range is set by taking the first operation position at which the user initially starts operation as a reference, and it is determined whether or not the operation constitutes erroneous operation by determining whether or not the second operation position, when final operation terminates, is within the operation valid range. If erroneous operation has been determined, then the detection of the second operation position is invalidated. Since the operation is invalidated, accordingly no processing based upon that operation is executed, and thereby erroneous operation can be prevented.

### BRIEF DESCRIPTION OF DRAWINGS

FIG. 1 is an overall figure showing a game machine to which a detection control system for a touch interface according to an embodiment of the present invention is applied;

FIG. 2 is a figure showing an example of a game screen;

FIG. 3 is a figure for explanation of erroneous operation when the game screen of FIG. 2 is used;

FIG. 4 is a functional block diagram for explanation of the structure of principal portions of a control system of a game machine;

FIG. 5 is a flow chart showing a detection control procedure that is executed by a control unit of the game machine; and

FIG. 6 is a figure for explanation of touch operation that utilizes the game screen of FIG. 2.

### DESCRIPTION OF EMBODIMENTS

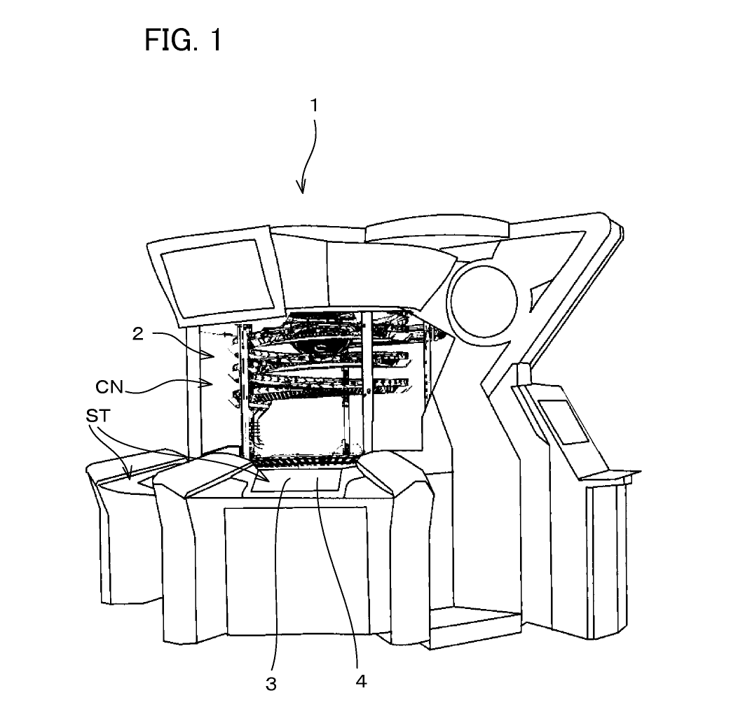

FIG. 1 is an overall figure showing a game machine 1 to which a detection control system 10 for a touch interface according to an embodiment of the present invention is applied. This game machine 1 is built as a game machine for commercial use (i.e. for business use) that charges a predetermined playing fee, and that permits the user to play a game within a range corresponding to that playing fee. This type of game machine is sometimes termed an arcade game machine. The game machine 1 is installed in a predetermined facility such a shop or the like, with the main objective of earning by allowing a large number of users to play the game repeatedly.

The game machine 1 is a so called medal game machine that utilizes medals as a game medium. The game machine 1 is provided with a center unit CN and a plurality of station units ST that are positioned around the periphery of this center unit CN. The center unit CN is provided with a physical lottery mechanism that injects a ball onto a roulette disk upon which a plurality of option pockets are provided and thereby randomly chooses an option, thus executing a lottery game. Each of the station units ST utilizes this lottery mechanism to execute games of a plurality of types. Each of the station units ST is provided with a medal insertion slot (not shown in the figures), a display device 3, and a transparent touch panel 4 that is laid over the display device 3. A game screen 100 is displayed upon the display device 3, and the game progresses upon the station unit ST according to operation of the touch panel 4 by the user. As one possible example, the display device 3 may be a liquid crystal display device, and any of various per se known types of display device may be employed. Moreover, the touch panel 4 is a touch panel 4 of the single touch type that can only detect operation at one point, even when operation at several points thereupon is performed at the same time. One or two persons can play on the station unit ST. When two people are playing, the both look at the same display device 3 while performing touch operation upon its touch panel 4. It should be understood that the touch panel 4 corresponds to the “touch interface”. Two types of touch interface exist: a single touch type that detects touch operation at only a single point, and a multi touch type that detects simultaneous touch operation at two or more points. With the single touch type, even when operation is performed at several points at the same time, only touching at a single point is detected.

Games of a plurality of types are provided by the game machine 1, and these games progress according to options that are randomly selected by the lottery mechanism 2 of the center unit CN. As this plurality of options, numbers 1 through 25 can be randomly chosen by the lottery mechanism 2. On the other hand, on the station units ST, games can be played whose game progression changes according to changing of blocks or panels that are linked to the numbers that are randomly chosen. For example, games of a plurality of types such as a block deletion game or a bingo game or the like may be supplied by the station units ST. A user selects a plurality of games that he/she wants to play, and can play the games that he/she has selected in parallel while the lottery game is executing. As one example, games of five types may be provided by the station unit ST, with the user being able to select three of those games and to play them in parallel. The user bets medals in each game, and various types of prizes such as payout of medals or items or the like are awarded according to the results of the games. Explanation of the rules of the various games will here be omitted. Per se known games may be provided.

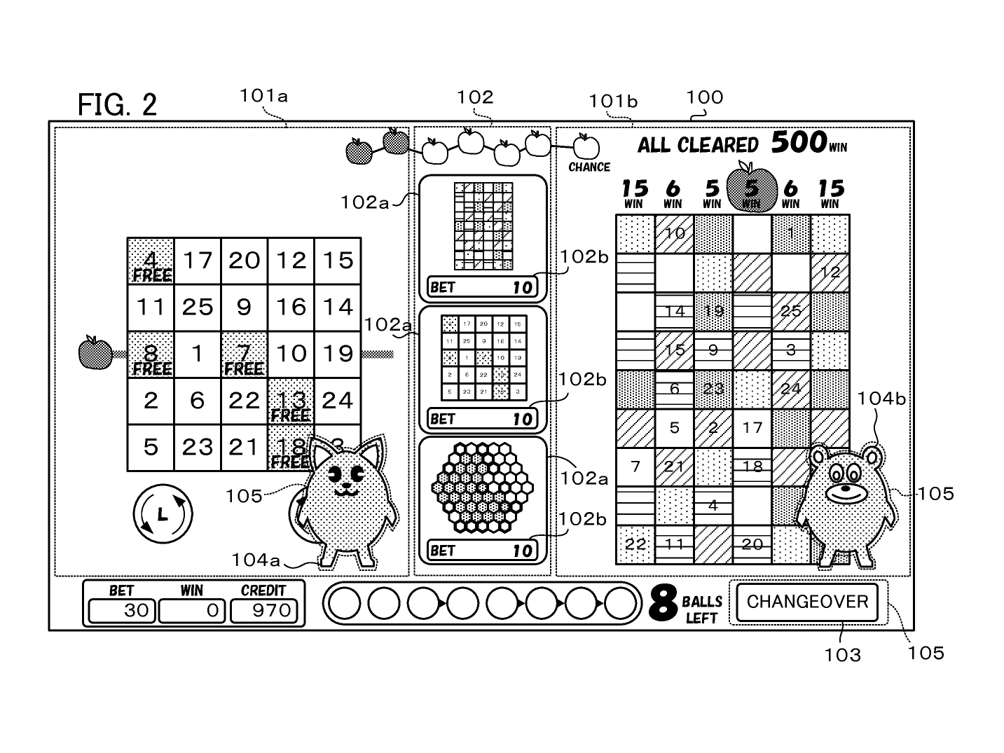

FIG. 2 is a figure showing an example of a game screen 100. This figure shows an example of a game screen for play by two persons. With two-person play, the display surface of the display device 3 is split into left and right portions, and a game region 101a for the first user and a game region 101b for the second user are provided upon the game screen 100. In each of these regions 101a and 101b, the game selected by the corresponding user is displayed in an appropriate manner. A game setting region 102 is provided in the center of the game screen 100, sandwiched between the regions 101a and 101b. Display selection buttons 102a for selecting games to be shown at larger screen size and bet buttons 102b that receive operation for betting medals upon games are provided in this game setting region 102. A user bets by performing touch operation upon the bet button 102b that corresponds to the game that he/she wants to play, and then selects a display selection button 102a and enjoys the selected game. Invalid operation region data 28 for this game setting region 102 is recorded in advance as an invalid operation region 122 that will be described hereinafter. And a changeover button 103 for changing over the screen according to a request from the user, and an environment setting region 105 that receives operation having no direct relationship with the progress of the game, such as initiation of actions to be performed by touch operation, handling characters 104a and 104b that can be cared, and so on, are provided upon the game screen 100 as appropriate.

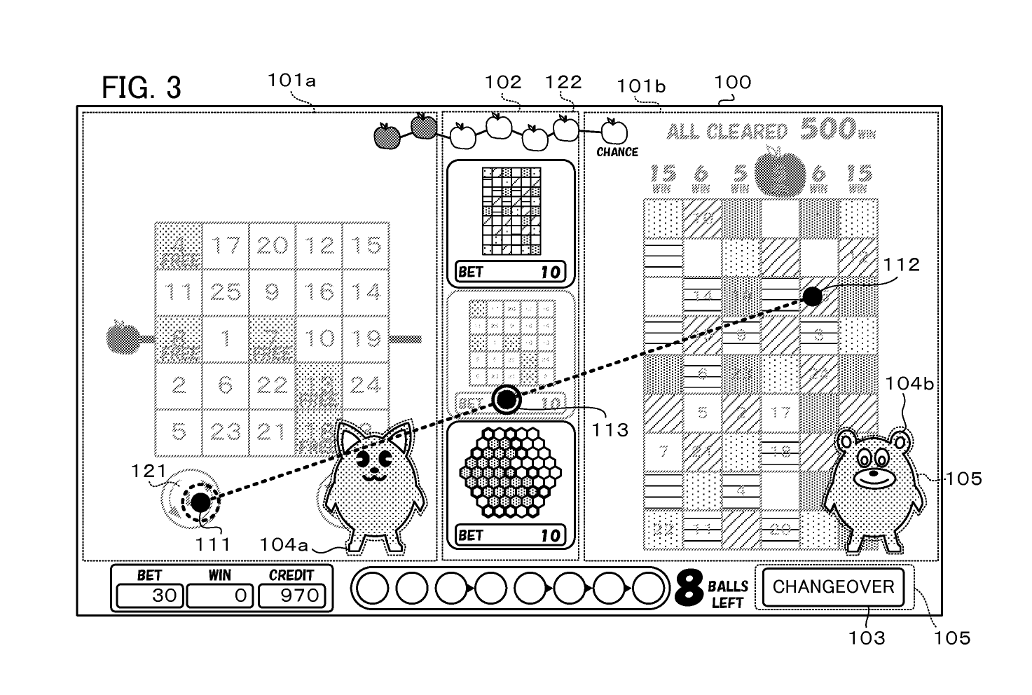

Since the touch panel 4 that is employed on the game machine 1 is a panel of the single touch type, accordingly, when two users are playing, there is a danger of erroneous operation if both the two users simultaneously perform touch operation upon the touch panel 4 at different positions. FIG. 3 is a figure for explanation of erroneous operation when the game screen of FIG. 2 is used. On the game screen 100a shown in FIG. 3, for convenience of explanation, part of the image is shown as being grayed-out. Usually the touch panel 4 operates normally, provided that there is no deviation of the timings of touch operation, and that the timings of operations do not overlap. Here, touch operation means a series of operations, from when the user touches the touch panel 4 and touch operation starts, until he/she removes his/her finger from the touch panel 4 and touch operation is terminated. The operation position when touch operation is terminated is detected as being the operation input position, and processing is executed on the basis thereof.

However, if several touch operations are performed simultaneously upon this single touch type touch panel 4, then erroneous operation occurs, since it is not capable of recognizing two points upon its structure at the same time. If, as shown in FIG. 3, the first user performs touch operation at an operation point 111, and, while this operation is continuing, the second user performs touch operation at another operation point 112, then a point 113 that is intermediate between these operation points 111 and 112 will be detected as being the operation point. When in this state the second user terminates his/her touch operation, then this operation point 113 will be recognized by the game machine 1 as being the operation input position. If this occurs, a different operation will be inputted from that intended by the users, and this will be a cause of erroneous operation. This type of phenomenon can take place with a touch panel of the resistive film type or the like. In the case shown in FIG. 3, due to erroneous operation, operation is performed to make a bet upon the bingo game, which is not what was desired by either of the users.

With the present invention, in order to prevent this type of erroneous operation, it is determined whether or not touch operation by the user is erroneous operation, and, in the case of erroneous operation, this touch operation is considered to be invalid. This determination of erroneous operation is performed by taking the position where the user has performed the initial touching in a series of operations as being a first operation position, by taking the position where he/she has performed the final touching as being a second operation position, by recording the coordinates of these two positions, and by determining whether or not the operation is erroneous according to the positional relationship between this first operation position and this second operation position. In the case of erroneous operation, control is performed to make this operation by the user invalid. The details will be explained hereinafter. It should be understood that the present invention is capable of determining erroneous operation if, while the first user is performing touch operation, the second user then performs touch operation, or the like, i.e. when the timing of a plurality of touch operations are partially overlapped, but the present invention cannot be applied when the timings of these two touch operations agree with one another perfectly. This is because, with the structure of this touch panel 4 which is of the single touch type, when the panel is touched and actuated simultaneously at two different positions, neither of those positions can be detected.

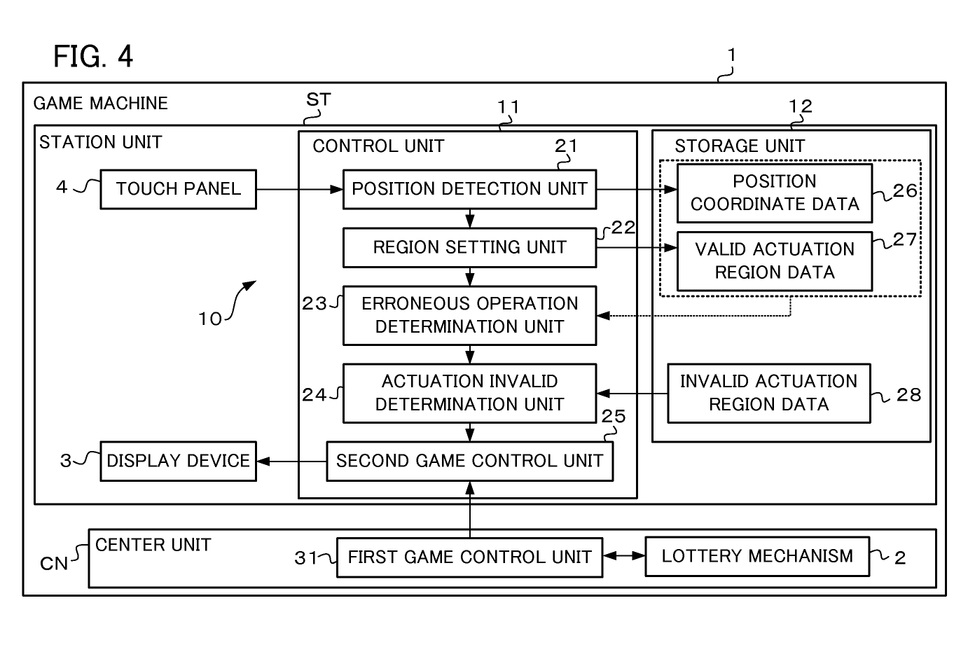

FIG. 4 is a functional block diagram for explanation of the structure of principal portions of the control system of the game machine 1. Each of the station units ST of the game machine 1 is provided with a control unit 11 and a storage unit 12. The control unit 11 is a computer unit that comprises a microprocessor and internal storage devices such as ROM in which programs to be executed by this microprocessor such as an operating system and so on are recorded, RAM that provides a working area for the microprocessor, and so on. And the storage unit 12 stores a game program to be executed by the control unit 11 and data of various types to be referred to by that program. This storage unit 12 is a storage device that can maintain storage, such as, for example, a hard disk storage device or the like. Position coordinate data 26, valid operation region data 27, and invalid operation region data 28 are stored in the storage unit 12. The detection control system 10 of the present invention may be provided to at least one of the touch panel 4, the control unit 11, and the storage unit 12.

A position detection unit 21, a region setting unit 22, an erroneous operation determination unit 23, an operation invalid determination unit 24, and a second game control unit 25 are provided internally to the control unit 11. These are logical devices that are implemented as combinations of computer hardware of the control unit 11 and predetermined software. Operation position coordinates from a first operation position at which the user performs touch operation to a second operation position are outputted at appropriate intervals by the touch panel 4. The position detection unit 21 acquires these position coordinate signals outputted from the touch panel 4, and records the coordinates of the first operation position and the coordinates of the second operation position as position coordinate data 26. The region setting unit 22 sets a valid operation region 121 of a predetermined size by taking the first operation position coordinates that have been recorded in the position coordinate data 26 as a reference, and records this valid operation region 121 in valid operation region data 27. For example, the region setting unit 22 may take the first operation position coordinates as a center and set a region of a predetermined radius around that center and surrounding it as being the valid operation region 121, and may record this region in the valid operation region data 27. The erroneous operation determination unit 23 determines whether or not the second operation position coordinates that have been recorded in the position coordinate data 26 are within this valid operation region 121. If the second operation position is not located within the valid operation region 121, then the operation invalid determination unit 24 determines whether or not the second operation position coordinates are within an invalid operation region 122. This invalid operation region 122 is a region in which operation is considered as being invalid if a predetermined condition is satisfied. The invalid operation region 122 is set in advance, and is recorded in invalid operation region data 28. And, on the basis of the results of determination by the erroneous operation determination unit 23 and by the operation invalid determination unit 24, the second game control unit 25 controls the progression of the game according to these detections of validity. Games of various types that utilize the random choice results of the lottery game executed by the center unit CN are executed by the second game control unit 25.

The first game control unit 31 is provided by the center unit CN of the game machine 1. This first game control unit 31 is a logical device that is implemented as a combination of computer hardware (including a CPU and a memory that serves as an internal storage device necessary for its operation) and software. The first game control unit 31 controls the operation of the lottery mechanism 2, and executes the lottery game.

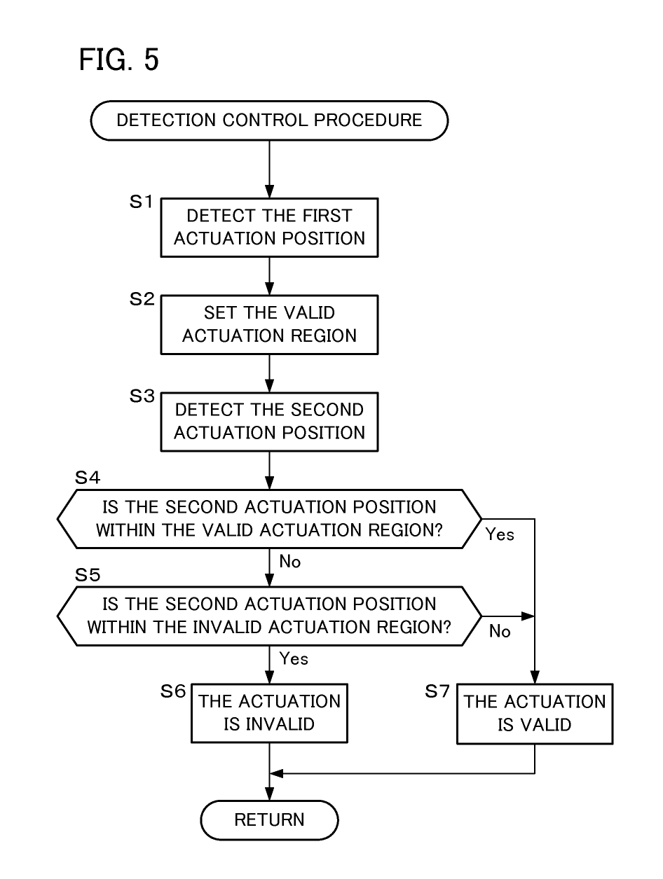

FIG. 5 is a flow chart showing a detection control procedure that is executed by a control unit of the game machine 1. This detection control procedure is executed when, with a game being played upon the station unit ST, the user performs touch operation upon the touch panel 4. When the control unit 11 acquires a new position coordinate signal from the touch panel 4, it detects the position that has been initially inputted as being the first operation position, and records its position coordinates in the position coordinate data 26 (in the step S1). It would be possible to record data for touch operation a plurality of times in the position coordinate data 26, or, alternatively, it would also be possible to delete the previous data, each time touch operation is performed once.

Then the valid operation region 121 is set (in the step S2) by taking the first operation position coordinates that have thus been recorded as a reference. The range for the valid operation region 121 is determined in advance. And when, subsequent to the step S1, the position coordinate signal from the touch panel 4 ceases, the control unit 11 detects the position at which this signal has been finally inputted as being the second operation position, and records its position coordinates in the position coordinate data 26 (in the step S3). The control unit 11 then determines whether or not the second operation position is within the valid operation region 121 (in the step S4). If the second operation position is included within the valid operation region 121, then the control unit 11 determines that this operation is valid (in the step S7), and terminates this episode of processing. The control unit 11 recognizes this second operation position as being the operation input position at which operation has been inputted by the user, and performs game control according to the appropriately corresponding command.

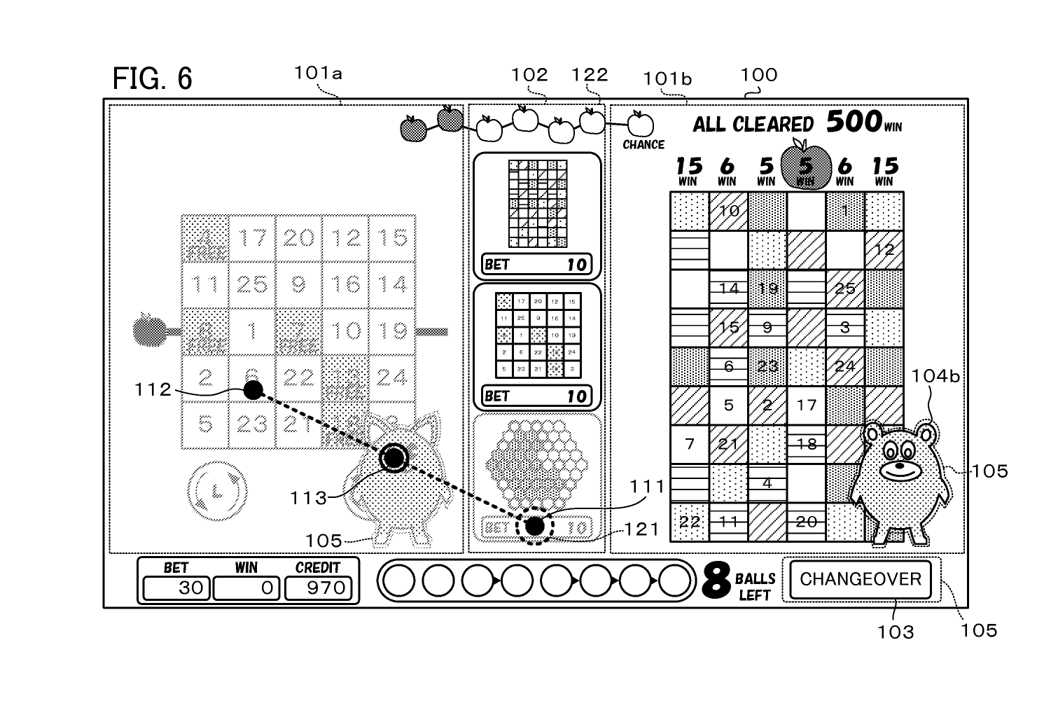

But if the second operation position is not included in the valid operation region 121, then the control unit 11 determines whether or not the second operation position is within the invalid operation region 122 (in the step S5). If, as shown in FIG. 3, the second operation position is included in the invalid operation region 122, then the control unit 11 takes this operation as being invalid (in the step S6), and terminates this episode of processing. On the other hand, if the second operation position is not included in the invalid operation region 122, then the control unit 11 takes this operation as being valid (in the step S7), and terminates this episode of processing. For example if, as shown in FIG. 6, while the first user is performing touch operation at the operation point 111, the second user performs touch operation at the operation point 112, then the position will jump to the operation point 113. In FIG. 6, the position of the operation point 113 to which operation has deviated is included within the environment setting region 105, and, even if this touch operation is taken as being valid, the only result is that the character 104a will perform some action upon the screen. Moreover, if the second operation position is located in a region in which operation cannot be received, then no influence is exerted upon the game even if this operation is taken as being valid. Accordingly, by taking the operation as being invalid only if the second operation position is included within the invalid operation region, it is possible to determine which operations may cause erroneous operation, and to make only such operations invalid.

In the processing described above, the processing of the steps S1 and S3 executed by the position detection unit 21 of the control unit 11 functions as the position detection device, the processing of the step S2 executed by the region setting unit 22 functions as the valid operation region setting device, the processing of the step S4 executed by the erroneous operation determination unit 23 functions as the position determination device, and the processing of the steps S5 and S6 executed by the operation invalid determination unit functions as the operation invalidation device.

The present invention is not limited to the form described above; various modifications could be made to this embodiment. For example while, in the above embodiment, the game setting region 102 has been explained as being the invalid operation region 122, this is not to be considered as being limitative. It would also be acceptable to arrange for the bet button 102b that receives operation for charging to be included in the invalid operation region 122. The region that is set as the invalid operation region 122 may be set as appropriate according to the game that is being played. Although in this embodiment, the explanation has focused upon the type of erroneous operation that occurs due to an intermediate position being detected when touch operation is performed at two locations at almost the same time, as shown in FIG. 3, the present invention is not limited to this type of erroneous operation. The present invention can be applied to various types of erroneous operation that cannot be predicted. With the present invention, by appropriately setting the valid operation region 121 and the invalid operation region 122, it is possible to invalidate the detection of any irregular position that the user does not intend to be detected.

While, in the embodiment described above, the application to a game machine 1 that can be played by a plurality of users has been explained, this is not to be considered as being limitative. The present invention can be applied to a display device of any of various types that is provided with a touch panel 4 of the single touch type, such as a display for a PC, a television, or the like. The present invention can be applied to various types of display device by setting an operation reception region where erroneous operation is not desired as being the invalid operation region 122, and by setting a valid operation region 121 to be appropriately actuated by the user. The term “touch interface” includes, not only a touch screen such as the touch panel 4 described above, but also a structure that is not necessarily assembled to a display, such as a touch pad, a touch tablet, or the like.

While, in the embodiment described above, in the detection control procedure of FIG. 5, after a negative decision in the step S4, it was decided whether or not to invalidate the detection of position by determining whether or not the second operation position was within the invalid operation region 122, this should not be considered as being limitative. It would also be acceptable, after a negative decision in the step S4, to arrange for the step S5 to be omitted, and for the operation to be taken as being invalid.

What is claimed is:

1. A detection control system for a touch interface that controls detection of a position of operation of a touch interface that employs the single touch method, comprising:
a position detection device that detects a series of operation positions upon the touch interface from a first operation position at which a user starts initial operation to a second operation position at which the user terminates final operation;
a valid operation region setting device that sets a predetermined valid operation region by taking the first operation position as a reference;
a position determination device that determines whether or not the second operation position has been detected within the valid operation region; and
an operation invalidation device that invalidates detection of the second operation position on the basis of a result of determination by the position determination device.

2. The detection control system of claim 1, wherein the operation invalidation device invalidates the detection of the second operation position, when the second operation position has not been detected within the valid operation region.

3. The detection control system of claim 1, wherein the operation invalidation device invalidates the detection of the second operation position, when the second operation position has not been detected within the valid operation region, and moreover the second operation position is positioned within a predetermined invalid operation region.

4. The detection control system of claim 3, wherein the invalid operation region includes an operation reception region in which further operation by the user is received.

5. The detection control system of claim 4, wherein:
the touch interface is provided to a game machine that charges a fee to the user for playing, and then permits the user to play a game; and
the operation reception region is a region that receives operation corresponding to the payment of the playing fee.

6. A detection control method for a touch interface that controls detection of a position of operation of a touch interface that employs the single touch method, comprising:
a position detection step of detecting a series of operation positions upon the touch interface from a first operation position at which a user starts initial operation to a second operation position at which the user terminates final operation;
a valid operation region setting step of setting a predetermined valid operation region by taking the first operation position as a reference;
a position determination step of determining whether or not the second operation position has been detected within the valid operation region; and
an operation invalidation step of invalidating detection of the second operation position on the basis of a result of determination by the position determination step.
